(19) United States
(12) Patent Application Publication
(10) Pub. No.: US 2013/0037006 A1
(43) Pub. Date: Feb. 14, 2013

(54) EVAPORATED FUEL TREATING APPARATUS

(71) Applicants: Ryuji Kosugi, Obu (JP); Toshikuni Kizu, Obu (JP); Takashi Kamiya, Ichinomiya (JP); Hiroaki Kitanaga, Obu (JP)

(72) Inventors: Ryuji Kosugi, Obu (JP); Toshikuni Kizu, Obu (JP); Takashi Kamiya, Ichinomiya (JP); Hiroaki Kitanaga, Obu (JP)

(73) Assignee: AISAN KOGYO KABUSHIKI KAISHA, Aichi-ken (JP)

(21) Appl. No.: 13/566,276

(22) Filed: Aug. 3, 2012

(30) Foreign Application Priority Data
Aug. 9, 2011 (JP) 2011-174075

(51) Int. Cl. F02M 33/02

(52) U.S. Cl. 123/520

(57) ABSTRACT

An evaporated fuel treating apparatus reduces blow-through of evaporated fuel components from an atmosphere port to an outside and has a fluid circulation passage which includes at one end side a first chamber containing granulated carbon or fractured carbon, and heat storage material and at another end side a second chamber containing granulated carbon or fractured carbon and not having the heat storage material. A delay diffusion chamber is disposed between the first chamber and the second chamber, which does not have activated carbon and the heat storage material therein. An adsorption amount of evaporated fuel of granulated or fractured carbon in the second chamber is set to be not less than 2 vol % and not more than 8 vol % of a total adsorption amount of evaporated fuel of granulated or fractured carbon, and a volume of the delay diffusion chamber is larger than that of the second chamber.

### BACKGROUND OF THE INVENTION

1. Field of the Invention

The present invention relates to an evaporated fuel treating apparatus.

2. Description of Related Art

Conventionally, there has been used an evaporated fuel treating apparatus (hereinafter, also referred to as a canister) which temporarily adsorbs fuel components in evaporated fuel in order to prevent the evaporated fuel from being emitted to the atmosphere from a fuel tank of an automobile, etc.

Recently, in a canister, it has been desired to reduce an amount of diffusion of evaporated fuel to the atmosphere. As a canister in which the amount of diffusion of the evaporated fuel to the atmosphere is reduced, a canister 101 described in JP-A-2010-7671, as shown in. FIG. 13, has been known. The canister 101 has a case 105 in which a tank port 102, a purge port 103, and an atmosphere port 104 have been formed, and in the case 105, a main adsorbent chamber 106, a second adsorbent chamber 107, and a third adsorbent chamber 108 are formed in that order from a tank port 102 side. Activated carbon and heat storage material are provided in the main adsorbent chamber 106 and the second adsorbent chamber 107, only activated carbon is provided in the third adsorbent chamber 108, and a plate member 109 having a throttle portion for suppressing diffusion of the evaporated fuel is provided between the second adsorbent chamber 107 and the third adsorbent chamber 108.

In the canister 101, diffusion of the evaporated fuel from the second adsorbent chamber 107 to the third adsorbent chamber 108 is suppressed by providing the plate member 109 having the throttle portion between the second adsorbent chamber 107 and the third adsorbent chamber 108, whereby blow-through of evaporated fuel components from the atmosphere port 104 to an outside is suppressed.

However, the above-described canister 101 of the conventional technology has few effects of delaying the diffusion of the evaporated fuel components from the second adsorbent chamber 107 to the third adsorbent chamber 108 by the throttle portion of the plate member 109. Therefore, it has been desired to reduce the blow-through of the evaporated fuel components from the atmosphere port 104 to the outside by reducing fuel components remaining in the third adsorbent chamber, as well as by more delaying the diffusion of the evaporated fuel components to the third adsorbent chamber 108.

### BRIEF SUMMARY OF THE INVENTION

Consequently, the present invention aims at providing an evaporated fuel treating apparatus in which blow-through of evaporated fuel components from an atmosphere port to an outside is reduced more than that in a canister of the conventional technology.

In order to solve the above-described problem, an evaporated fuel treating apparatus according to the present invention comprises a passage in which a fluid can circulate, a tank port and a purge port formed at one end side of the passage, and an atmosphere port formed at an other end side thereof,

wherein at the one end side of the passage, provided is a heat storage element containing chamber inside which granulated carbon or fractured carbon, and heat storage material made by encapsulating in a capsule phase-change material causing absorption and emission of latent heat according to temperature change are contained, at the other end side of the passage, provided is a heat storage element non-containing chamber inside which granulated carbon or fractured carbon are disposed, and which does not have the heat storage element, and, between the heat storage element containing chamber and the heat storage element non-containing chamber, provided is a delay diffusion chamber which does not have activated carbon and the heat storage material therein,

wherein an amount of adsorption of evaporated fuel of granulated carbon or fractured carbon in the heat storage element non-containing chamber is set to be not less than 2 vol % and not more than 8 vol % of a total amount of adsorption of evaporated fuel of the granulated carbon or fractured carbon, and

wherein a volume of the delay diffusion chamber is larger than a volume of the heat storage element non-containing chamber.

In the present invention, a length in an axial direction of the heat storage element non-containing chamber may be not less than 2 mm and not more than 30 mm.

In the present invention, a throttle portion which reduces a circulation area of a fluid may be formed at both ends of the delay diffusion chamber.

In the present invention, an auxiliary adsorption chamber inside which activated carbon formed into a honeycomb shape is disposed, and which does not have the heat storage element may be provided at an other end side of the heat storage element non-containing chamber.

If heat storage material were contained also in the heat storage element non-containing chamber of the present invention, a remaining amount of fuel components in the heat storage element non-containing chamber could be reduced. However, when a capacity of the heat storage element non-containing chamber is reduced, in a case that the heat storage material in the heat storage element non-containing chamber are arranged in an unbalanced manner, there is a fear that the fuel components pass through between the heat storage material arranged in the unbalanced manner and are discharged from the atmosphere port without being adsorbed by activated carbon. Therefore, by not containing the heat storage material in the heat storage element non-containing chamber, the pass-through of the fuel components due to the unbalanced arrangement of the heat storage material can be prevented, thereby stabilizing the blow-through performance.

In addition, when a volume of the heat storage element non-containing chamber is large, since fuel components which remain in the heat storage element non-containing chamber are increased, there is a fear that a blow-through amount is increased. Thus, the adsorption amount of the evaporated fuel of granulated carbon or fractured carbon in the heat storage element non-containing chamber is set to be not less than 2 vol % and not more than 8 vol % of the total adsorption amount of evaporated fuel of the granulated carbon or the fractured carbon, so as to improve the blow-through performance.

The delay diffusion chamber having a volume larger than that of the heat storage element non-containing chamber is provided between the heat storage element non-containing chamber and the heat storage element containing chamber, whereby diffusion of the fuel components adsorbed in the heat storage element containing chamber to the heat storage element non-containing chamber can be delayed, to suppress fuel components flowing into the heat storage element non-containing chamber to be low, and the blow-through amount of evaporated fuel discharged from the atmosphere port to the atmosphere can be suppressed to be low.

### BRIEF DESCRIPTION OF SEVERAL VIEWS OF DRAWINGS

FIG. 1 is a cross-sectional view of an evaporated fuel treating apparatus according to Embodiment 1 of the present invention;

FIG. 2 is a cross-sectional view taken along a line in FIG. 1;

FIG. 3 is a plan view of a space forming member used for Embodiment 1 of the present invention;

FIG. 4 is a transverse cross-sectional view of the member in FIG. 3;

FIG. 5 is a side view taken in a direction of arrows V-V in FIG. 3;

FIG. 6 is a cross-sectional view taken along a line VI-VI in FIG. 5;

FIG. 7 is a perspective view seen from a left lower side in FIG. 3;

FIG. 8 is a perspective view seen from a right side in FIG. 3;

FIG. 9 is a graph of a blow-through amount with respect to a ratio of an adsorption amount of evaporated fuel components of granulated carbon or fractured carbon in a third adsorbent chamber to a total adsorption amount of evaporated fuel components of granulated carbon or fractured carbon in the evaporated fuel treating apparatus according to Embodiment 1 of the present invention;

FIG. 10 is a graph of a blow-through amount with respect to a length in an axial direction of a third adsorbent chamber according to Embodiment 1 of the present invention;

FIG. 11 is a schematic configuration cross-sectional view of an evaporated fuel treating apparatus according to Embodiment 3 of the present invention seen from an upper side;

FIG. 12 is a cross-sectional view taken along a line XII-XII in FIG. 11; and

FIG. 13 is a schematic configuration cross-sectional view showing a conventional evaporated fuel treating apparatus.

### DETAILED DESCRIPTION OF THE INVENTION

Modes for carrying out the present invention will be described based on accompanying drawings.

### Embodiment 1

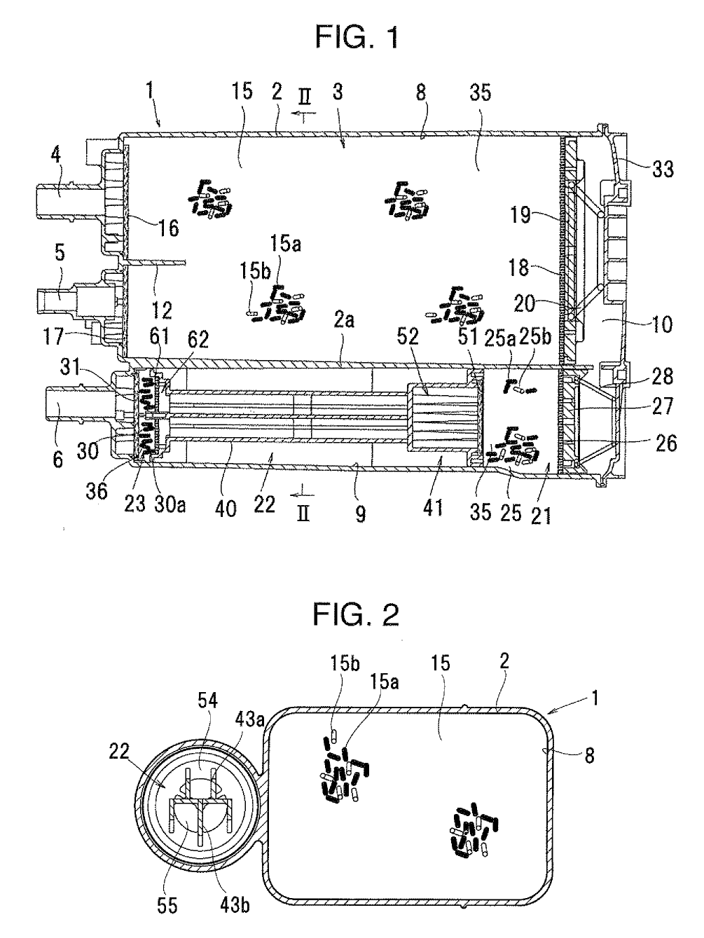

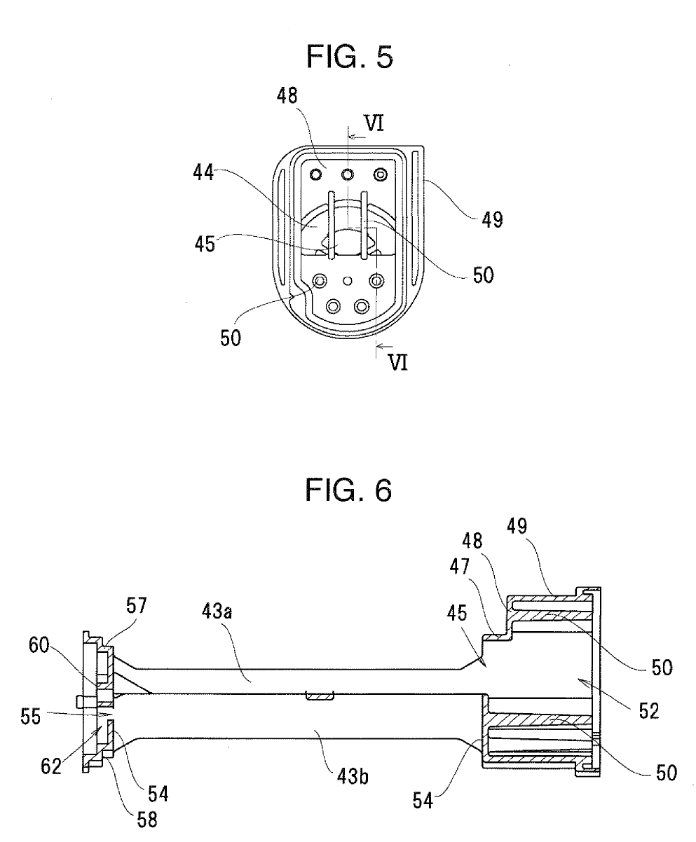

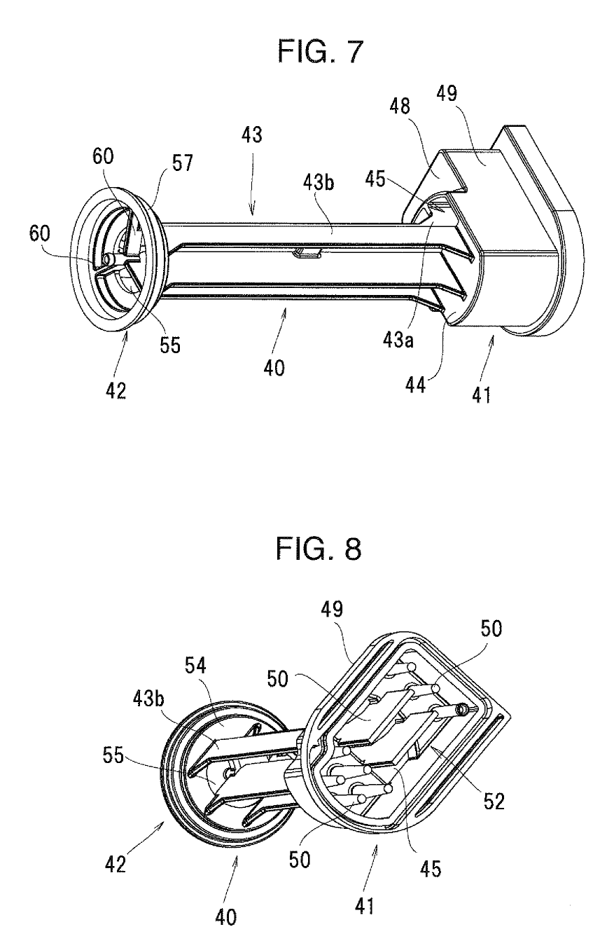

FIGS. 1 to 8 show Embodiment 1 according to the present invention.

FIG. 1 shows a cross-sectional view of an evaporated fuel treating apparatus 1, and the evaporated fuel treating apparatus 1 is used being installed in an automobile etc. so that right and left sides of the apparatus shown in FIG. 1 correspond to a lateral direction, or the left side corresponds to an upper side. Hereinafter, the evaporated fuel treating apparatus 1 will be described in a state of being attached to the automobile etc. so that the right and left sides of the apparatus in FIG. 1 correspond to the lateral direction, and the upper and lower sides of the apparatus in FIG. 2 correspond to a vertical direction.

The evaporated fuel treating apparatus 1 has a case 2, a passage 3 through which a fluid can circulate is formed inside the case 2, and as shown in FIG. 1, a tank port 4 and a purge port 5 are formed at an end of one end side of the passage 3 in the case 2, and an atmosphere port 6 is formed at an end of an other end side thereof. It is to be noted that hereinafter, the evaporated fuel treating apparatus 1 will be described also defining a tank port 4 side as one end side, and an atmosphere port 6 side as the other end side.

In the case 2, a main chamber 8 communicating with the tank port 4 and the purge port 5, and an auxiliary chamber 9 communicating with the atmosphere port 6 are formed, the main chamber 8 and the auxiliary chamber 9 are partitioned by a partition wall 2a, the main chamber 8 and the auxiliary chamber 9 communicate with each other in a space 10 formed at an opposite side to the atmosphere port 6 side in the case 2, and a gas returns in the space 10 to flow in a substantially U-shaped manner in the gas flowing from the tank port 4 into the atmosphere port 6.

The tank port 4 communicates with an upper air chamber of a fuel tank through a valve which is not shown, and the purge port 5 is connected to an engine intake air passage through a purge control valve (VSV) and a purge passage which are not shown. An opening of the purge control valve is controlled by an ECU (electronic control unit), and purge control is performed in engine operation.

Between the tank ports 4 and the purge ports 5 in the case 2, provided is a baffle plate 12 which reaches a part of a first adsorbent layer 15, which will be described hereinafter, from an internal surface of the case 2. By the baffle plate 12, a fluid flowing between the tank port 4 and the purge port 5 circulates through the first adsorbent layer 15, which will be described hereinafter.

In the main chamber 8, provided is the first adsorbent layer 15 formed by filling it with activated carbon 15a at a predetermined density and heat storage material 15b made by encapsulating in a microcapsule phase change material causing absorption and emission of latent heat according to temperature change. The activated carbon 15a configuring the first adsorbent layer 15 is configured with granulated carbon of a predetermined average particle diameter. It is to be noted that the activated carbon 15a may be configured with fractured carbon. It is preferable that an amount of the heat storage material 15b in the first adsorbent layer 15 is 5 to 40% (w/w) with respect to the activated carbon 15a in the first adsorbent layer 15, and the amount is set to be 30% (w/w) in the embodiment. In addition, in the embodiment, it is configured such that when a temperature of the heat storage material 15b decreases to a temperature not more than an operative temperature, latent heat associated with phase change of the phase change material in the heat storage material 15b is generated, and decrease in temperature of the activated carbon at the time of purge is suppressed.

The first adsorbent layer 15 is covered with a filter 16 configured with non-woven fabric etc. at a tank port 4 side thereof, and is covered with a filter 17 configured with non-woven fabric etc. at a purge port 5 side thereof. In addition, a filter 18 configured with urethane etc. is provided on a bottom surface of the first adsorbent layer 15, the filter 18 covering the whole bottom surface, and a plate 19 having a number of communicating holes is provided at a lower side of the filter 18. The plate 19 is biased to the tank port 4 side by elastic means 20, such as a spring.

In the auxiliary chamber 9, a second adsorbent chamber 21, a delay diffusion chamber 22, and a third adsorbent chamber 23 are formed in that order from the tank port 4 side.

In the second adsorbent chamber 21, provided is a second adsorbent layer 25 formed by filling it at a predetermined density with activated carbon 25a and heat storage material 25b similar to the heat storage material 15b in the first adsorbent layer 15. The activated carbon 25a configuring the second adsorbent layer 25 is configured with granulated carbon of a predetermined average particle diameter. It is to be noted that the activated carbon 25a may be configured with fractured carbon. It is preferable that an amount of the heat storage material 25b in the second adsorbent layer 25 is 5 to 40% (w/w) with respect to the activated carbon 25a in the second adsorbent layer 25, and the amount is set to be 30% (w/w) in the embodiment.

A filter 26 configured with urethane etc. is provided on the second adsorbent layer 25 at a space 10 side, the filter 26 covering whole of the second adsorbent layer 25. A plate 27 which is substantially equally provided with a number of communicating holes in a whole surface is provided on the filter 26 on a space 10 side. The plate 27 is biased to the atmosphere port 6 side by an elastic member 28, such as a spring.

The space 10 is formed between the plates 19, 27 and a cover plate 33 of the case 2, and the second adsorbent layer 25 and the first adsorbent layer 15 communicate with each other through the space 10.

In the third adsorbent chamber 23, provided is a third adsorbent layer 30 formed by filling it with activated carbon 30a at a predetermined density. The activated carbon 30a configuring the third adsorbent layer 30 is configured with granulated carbon of a predetermined average particle diameter. It is to be noted that the activated carbon 30a may be configured with fractured carbon. The heat storage material provided in the main chamber 8 and the second adsorbent chamber 21 are not disposed in the third adsorbent chamber 23.

A filter 31 configured with non-woven fabric etc. is provided on the third adsorbent layer 30 at the atmosphere port 6 side, the filter 31 covering whole of the third adsorbent layer 30.

With the main chamber 8 and the second adsorbent chamber 21 which have the heat storage material 15b and 25b therein, configured is a heat storage element containing chamber 35, and with the third adsorbent chambers 23 which do not have heat storage material therein, configured is a heat storage element non-containing chamber 36.

Next, the delay diffusion chamber 22 will be described in detail.

A volume in the delay diffusion chamber 22 is, as shown in FIG. 1, set to be larger than a volume of the third adsorbent chamber 23, which is the heat storage element non-containing chamber 36.

Between the second adsorbent chamber 21 and the third adsorbent chamber 23 in the case 2, as shown in FIG. 1, provided is a space forming member 40 for forming the delay diffusion chamber 22. The space forming member 40, as shown in FIGS. 2 to 8, has a first partition portion 41 provided at an end on a side of the second adsorbent chamber 21, and a second partition portion 42 provided at an end on a side of the third adsorbent chamber 23, and the first partition portion 41 and the second partition portion 42 are integrally coupled with each other by a coupling portion 43.

The first partition portion 41 has a first partition wall 44 at an end on the side of the atmosphere port 6, and a first throttle portion 45 which reduces a flow of the fluid in a surface and rear-face direction of a first partition wall 44 is formed on the first partition wall 44.

The first throttle portion 45 is provided at a top side (an upper side) of the first partition wall 44, and a shape, a size, and the number thereof is arbitrarily set.

A cylinder-shaped cylindrical portion 47 protruding in a space 10 direction is formed at an outer periphery of the first partition wall 44, a flange portion 48 whose diameter is expanded in an outside direction is formed at an end of the cylindrical portion 47 on the space 10 side, and an outer cylinder 49 protruding in the space 10 direction is formed at an outer periphery of the flange portion 48.

A plurality of gap forming members 50 protruding in the space 10 direction are provided on the first partition wall 44 and at the flange portion 48. End surfaces of the plurality of gap forming members 50 on the space 10 side are located to retreat inside from an end surface of the outer cylinder 49 on the space 10 side, and are formed so as to be located on substantially the same surface. A filter 51 configured with urethane etc. is removably stored at the end of the outer cylinder 49 on the space 10 side, one surface of the filter 51 is provided in contact with the gap forming members 50, the filter 51 is spaced apart from the first partition wall 44, and a gap 52 communicating with the first throttle portion 45 is formed between the filter 51 and the first partition wall 44. In addition, the end surfaces of the outer cylinder 49 on the space 10 side and the filter 51 are formed so as to be substantially the same surface.

The second partition portion 42 has a second partition wall 54 at an end on the space 10 side, and a second throttle portion 55 which reduces a flow of a fluid in a surface and rear-face direction of the second partition wall 54 is formed on the second partition wall 54. The second throttle portion 55 is, as shown in FIG. 2, provided in a center of the second partition wall 54, and a shape, a size, and the number thereof are arbitrarily set.

A cylinder-shaped cylindrical portion 57 protruding in an atmosphere port 6 direction is formed at an outer periphery of the second partition wall 54, a flange portion 58 whose diameter is expanded in an outside direction is formed at an end of the cylindrical portion 57 on the atmosphere port 6 side, and an outer cylinder 59 protruding in the atmosphere port 6 direction is formed at an outer periphery of the flange portion 58.

A plurality of gap forming members 60 protruding in the atmosphere port 6 direction are provided on the second partition wall 54. End surfaces of the plurality of gap forming members 60 on the atmosphere port 6 side are located to retreat inside from an end surface of the outer cylinder 59 on the atmosphere port 6 side, and are formed so as to be located on substantially the same surface. A filter 61 configured with urethane etc. is removably stored on the atmosphere port 6 side of the end of the gap forming member 60 on the atmosphere port 6 side in the inner space of the outer cylinder 59, the filter 61 is provided in contact with the gap forming members 60 at one surface, the filter 61 is spaced apart from the second partition wall 54, and a gap 62 communicating with the second throttle portion 55 is formed between the filter 61 and the first partition wall 54. In addition, end surfaces of the outer cylinder 59 and the filter 61 on the atmosphere port 6 side are formed so as to be substantially the same surface.

The coupling portion 43 is, as shown in FIGS. 1 to 8, configured with two top side coupling members 43a formed into a plate shape and three bottom side coupling members 43b formed into a plate shape.

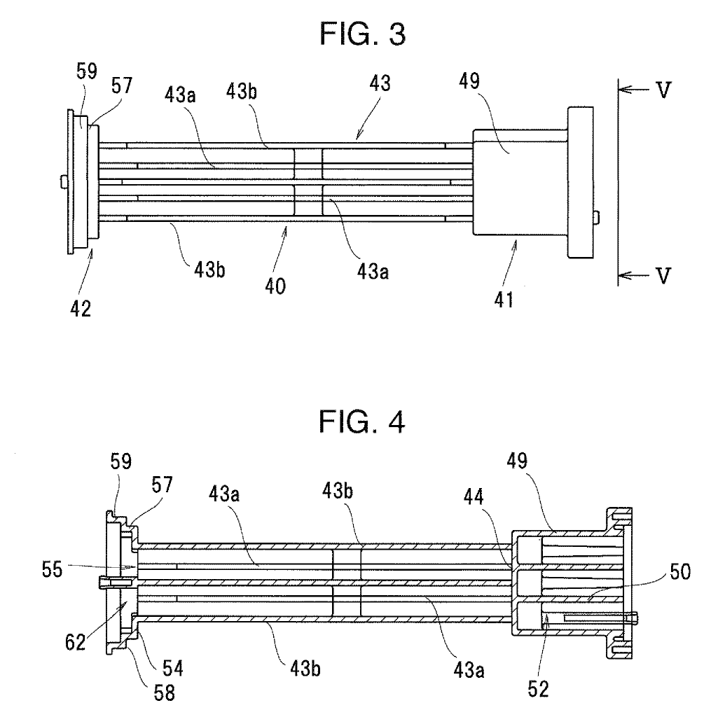

One end of the top side coupling member 43a is, as shown in FIGS. 3 to 8, located at the adjacent first throttle portion 45 on the first partition wall 44, and the top side coupling member 43a is located at an upper part of the adjacent second throttle portion 55 on the opposed second partition wall 54 so as to be installed as a bridge, and is provided so that the surface and the rear-face of the top side coupling member 43a are located in a top and bottom direction. In addition, each heaven side coupling member 43a is formed so as to be perpendicular to both the partition walls 44 and 54.

Each below side coupling member 43b is, as shown in FIGS. 1 to 8, installed as a bridge between a bottom side of the first partition wall 44 and a lower part of the second partition wall 54, and is provided so that surface and rear-surface thereof are arranged in the top and bottom direction. In addition, a part of the bottom side coupling member 43b is located at a lower part of the second throttle portion 55. Each bottom side coupling member 43b is provided so as to be perpendicular to both the partition walls 44 and 54.

With the above-described configuration, gas including evaporated fuel flowed into the evaporated fuel treating apparatus 1 from the tank port 4, flows into the first adsorbent chamber 15, the space 10, and the second adsorbent chamber 21 and subsequently, passes through the filter 51 and the gap 52, and flows into the delay diffusion chamber 22 from the first throttle portion 45.

Subsequently, after the gas is diffused in the top and bottom direction in the delay diffusion chamber 22 and heavy components of the fuel components settle out to cause a concentration gradient in the top and bottom direction, the gas passes through the second throttle portion 54, diffuses in the whole gap 62 and subsequently, passes through the filter 61 to flow into the third adsorbent chamber 23, and then, it is discharged from the atmosphere port 6 to the atmosphere. During this period, the fuel components are adsorbed by the activated carbon 15a, 25a, and 30a.

Meanwhile, in a case of purge control in engine operation, a purge control valve is opened by an ECU (electronic control unit), the air suctioned in the evaporated fuel treating apparatus 1 from the atmosphere port 6 by a negative pressure in an intake air passage flows in an opposite direction to the above, and is supplied to an engine intake air passage from the purge port 5. At that time, the fuel components having been adsorbed by the activated carbon 15a, 25a and 30a desorb, and are supplied to an engine with the air. In addition, decrease in temperature of the activated carbon 15a and 25a is suppressed by the heat storage material 15b and 25b, and a desorption amount from the activated carbon 15a and 25a is increased.

Next will be described a relation between a ratio of an amount of adsorption of the evaporated fuel components of the activated carbon (granulated carbon or fractured carbon) 30a in the third adsorbent chamber 23 in a total amount of adsorption of the evaporated fuel components of the activated carbon (granulated carbon or fractured carbon) 15a, 25a and 30a in the evaporated fuel apparatus 1, and blow-through performance.

First, a measuring method of blow-through performance will be described.

Blow-through performance was measured by a DBL (Diurnal Breathing Loss) test. In the DBL test, adsorption and desorption of gasoline vapor are repeated a plurality of times, and a gas remaining amount in an evaporated fuel apparatus is stabilized. Subsequently, mixed gas made by 50 vol % of butane and 50 vol % of nitrogen is introduced from a tank port to a canister at 25° C. at a rate of 40 g/h, and supply of the mixed gas is stopped at the time of breakthrough of 2 g of butane from an atmosphere port. Subsequently, after the mixed gas in the canister is left at 25° C., it is purged with a predetermined amount of air, and is left at 18.3° C. The evaporated fuel apparatus is connected to a fuel tank in which 40% of fuel of a tank capacity is stored, a temperature of the evaporated fuel apparatus is raised from 18.3° C. to 40.6° C. for twelve hours and subsequently, the temperature thereof is lowered to 18.3° C. for twelve hours. This process is repeated twice, and a maximum amount of HC leakage from the atmosphere port of the evaporated fuel apparatus is measured.

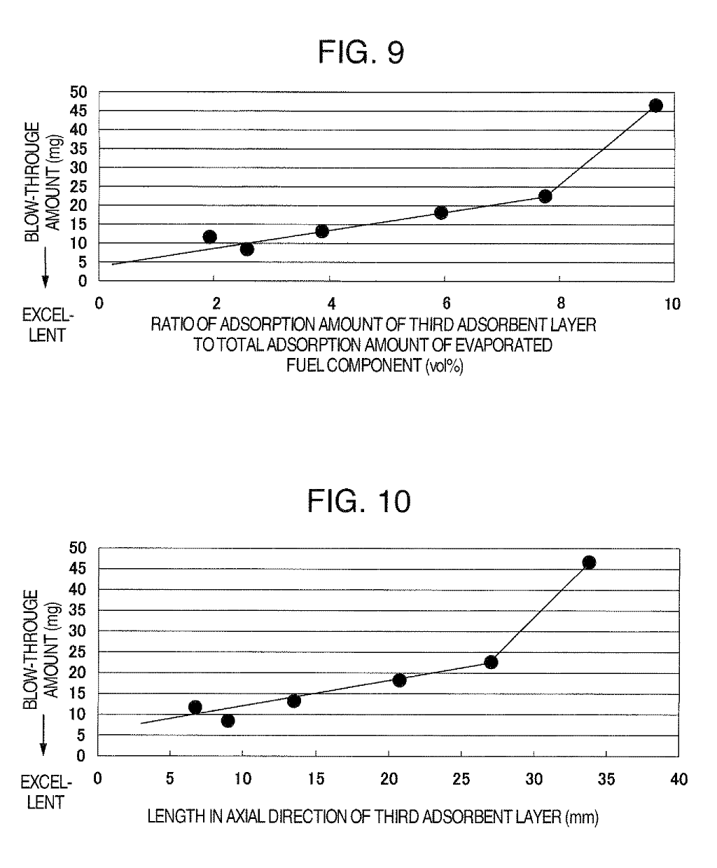

In FIG. 9, shown is change of a blow-through amount by the above-described DBL method in changing a ratio of an adsorption amount of the evaporated fuel components of granulated carbon or fractured carbon 30a in the third adsorbent chamber 23 in a total adsorption amount of the evaporated fuel components of granulated carbon or fractured carbon 15a, 25a, and 30a in the evaporated fuel apparatus 1.

It can be seen from FIG. 9 that a blow-through characteristic is good when not more than 8 vol % is the ratio of the adsorption amount of the evaporated fuel components of the activated carbon (granulated carbon or fractured carbon) 30a in the third adsorbent chamber 23 in the total adsorption amount of the evaporated fuel components of the activated carbon (granulated carbon or fractured carbon) 15a, 25a and 30a in the evaporated fuel apparatus 1. When not more than 2 vol % is the ratio of the adsorption amount of the evaporated fuel components of the activated carbon (granulated carbon or fractured carbon) 30a in the third adsorbent chamber 23 in the total adsorption amount of the evaporated fuel components of the activated carbon (granulated carbon or fractured carbon) 15a, 25a and 30a in the evaporated fuel apparatus 1, it is difficult to manufacture the evaporated fuel treating apparatus 1.

As described above, it turns out that the blow-through performance improves if not less than 2 vol % and not more than 8 vol %, further preferably not less than 2 vol % and not more than 4 vol %, is the ratio of the adsorption amount of the evaporated fuel components of the activated carbon (granulated carbon or fractured carbon) 30a in the third adsorbent chamber 23 in the total adsorption amount of the evaporated fuel components of the activated carbon (granulated carbon or fractured carbon) 15a, 25a and 30a in the evaporated fuel apparatus 1. In the embodiment, the adsorption amounts of the activated carbon (granulated carbon) 15a and 25a of the main chamber 8 and the second adsorbent chamber 21 which configure the heat storage element containing chamber 35 were set to be 86 to 91 g, and an adsorption amount of the activated carbon (granulated carbon) 30a of the third adsorbent chamber 23 which configures the heat storage element non-containing chamber 36 was set to be 2.22 g. Namely, set to be 2.38% to 2.5% was the ratio of the adsorption amount of the evaporated fuel components of the activated carbon (granulated carbon) 30a in the third adsorbent chamber 23 in the total adsorption amount of the evaporated fuel components of the activated carbon (granulated carbon) 15a, 25a and 30a in the evaporated fuel apparatus 1.

In FIG. 10, change of the blow-through characteristic in changing an axial length of the third adsorbent layer 30 is shown by the above-described DBL method A cross-sectional area of the third adsorbent layer 30 perpendicular to the axis in measuring the change is 21 cm².

It can be seen from FIG. 10 that the blow-through characteristic is good when the axial length of the third adsorbent layer 30 is not more than 30 mm. In addition, it is necessary to set the axial length of the third adsorbent layer 30 to be thicker than a diameter of the activated carbon. In the embodiment, the diameter of the activated carbon 15a, 25a and 30a was set to be 2 mm.

As described above, it turns out that the blow-through performance improves when the axial length of the third adsorbent layer 30 is set not less than 2 mm and not more than 30 mm, and further preferably, not less than 5 mm and not more than 15 mm.

With the above-described structure and configuration, the evaporated fuel treating apparatus 1 according to the present invention achieves the following function and effect.

If heat storage material are disposed in the third adsorbent chamber 23, a remaining amount of the fuel components of the third adsorbent layer 30 can be reduced. However, when a capacity of the third adsorbent chamber 23 is reduced, in a case that the heat storage material in the third adsorbent chamber 23 are arranged in an unbalanced manner, there is a fear that fuel components pass through between the heat storage material arranged in the unbalanced manner, and are discharged from the atmosphere port 6 without being adsorbed by the activated carbon. Therefore, by not disposing the heat storage material in the third adsorbent chamber 23, pass-through of the fuel components due to the unbalanced arrangement of the heat storage material can be prevented, thereby stabilizing the blow-through performance.

In addition, when a volume of the third adsorbent chamber 23 which is the heat storage element non-containing chamber 36 is large, since fuel components which remain in the third adsorbent chamber 30 are increased, there is a fear that a blow-through amount is increased. Thus, the adsorption amount of the evaporated fuel of granulated carbon or fractured carbon in the third adsorbent chamber 23, which is the heat storage element non-containing chamber 36, is set to be not less than 2 vol % and not more than 8 vol % of a total adsorption amount of the evaporated fuel of granulated carbon or fractured carbon, thereby improving the blow-through performance.

The delay diffusion chamber 22 having a volume larger than that of the third adsorbent chamber 23, which is the heat storage element non-containing chamber 36, is provided between the second adsorbent chamber 21 and the third adsorbent chamber 23, whereby fuel components adsorbed by the first adsorbent layer 15 and the second adsorbent chamber 35 can be delayed to diffuse to the third adsorbent layer 30, fuel components flowed into the third adsorbent layer 30 can be suppressed to be low, and a blow-through amount of the evaporated fuel discharged from the atmosphere port 6 to the atmosphere can be suppressed to be low.

It is to be noted that although the delay diffusion chamber 22 is formed by the space forming member 40, if the delay diffusion chamber 22 can be formed between the second adsorbent chamber 21 and the third adsorbent chamber 23, the delay diffusion chamber 22 may be formed by deforming a case and arbitrary members other than the space forming member 40.

### Embodiment 2

Although in Embodiment 1, the heat storage element containing chamber 35 is configured with the main chamber 8 and the second adsorbent chamber 21 which have the heat storage material 15b and 25b therein and the heat storage element non-containing chamber 36 is configured with the third adsorbent chambers 23 which do not have heat storage material therein, the number of the chambers configuring the heat storage element containing chamber and the heat storage element non-containing chamber 36 may be a single or plural, and can be arbitrarily set.

Since other structures are similar to those of Embodiment 1, descriptions thereof will be omitted.

An effect similar to that in Embodiment 1 is achieved also in Embodiment 2.

### Embodiment 3

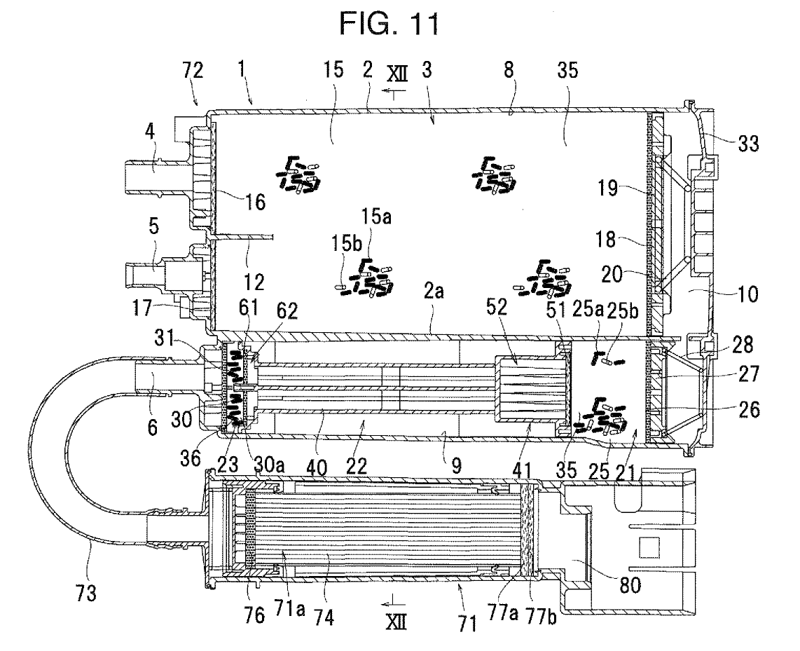

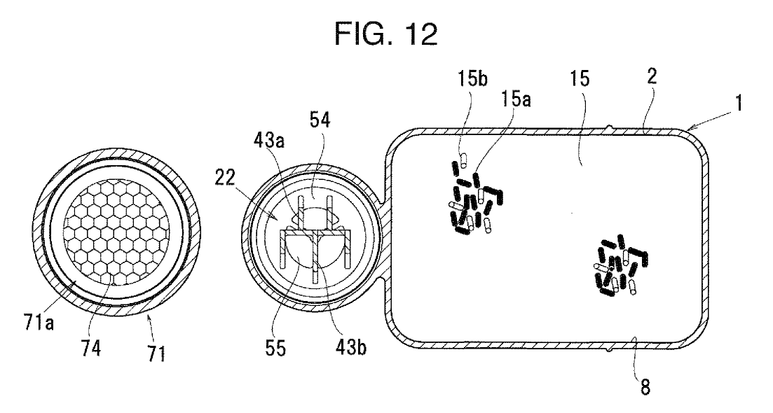

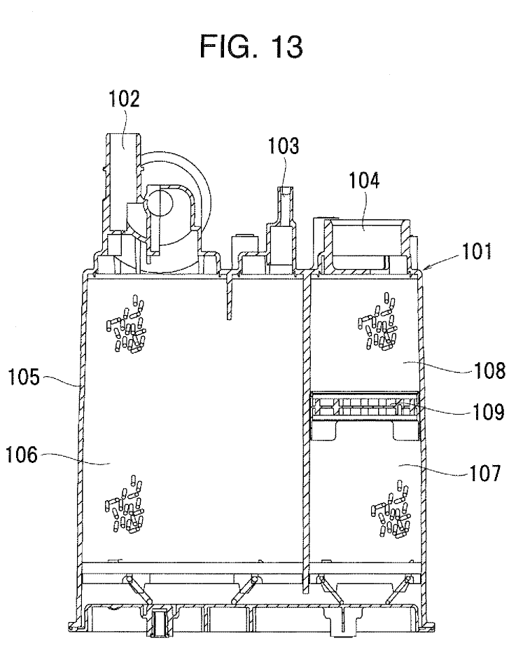

Embodiment 3 is, as shown in FIG. 11, an evaporated fuel apparatus 72 in which a sub-canister 71 is attached to the atmosphere port 6 of the evaporated fuel apparatus 1 of Embodiments 1 and 2 through a communicating pipe 73.

An auxiliary adsorption chamber 71a is formed in the sub-canister 71, activated carbon 74 formed into a honeycomb shape is stored in the auxiliary adsorption chamber 71a, and heat storage material are not disposed in the sub-canister. The activated carbon 74 is covered on a third adsorbent chamber 23 side, with a filter 76 configured with urethane etc., and on an opposite side thereto, is covered with filters 77a and 77b which are configured with two non-woven fabrics, etc.

In the evaporated fuel apparatus 72, reference numeral 80 in FIG. 11 corresponds to an atmosphere port.

Since other structures are similar to those of Embodiments 1 and 2, descriptions thereof will be omitted.

An effect similar to that in Embodiments 1 and 2 is achieved also in Embodiment 3.

1. An evaporated fuel treating apparatus comprising:
a passage in which a fluid can circulate;
a tank port and a purge port formed at one end side of the passage; and
an atmosphere port formed at an other end side of the passage,
wherein at the one end side of said passage, provided is a heat storage element containing chamber in which granulated carbon or fractured carbon, and heat storage material made by encapsulating in a capsule a phase change material causing absorption and emission of latent heat according to temperature change are disposed, and at the other end side of said passage, provided is a heat storage element non-containing chamber in which granulated carbon or fractured carbon is disposed and which does not have the heat storage material, and between said heat storage element containing chamber and said heat storage element non-containing chamber, provided is a delay diffusion chamber which does not have activated carbon and the heat storage material therein,
wherein an adsorption amount of evaporated fuel of the granulated carbon or fractured carbon in said heat storage element non-containing chamber is set to be not less than 2 vol % and not more than 8 vol % of a total adsorption amount of evaporated fuel of the granulated carbon or fractured carbon, and
wherein a volume of said delay diffusion chamber is larger than a volume of said heat storage element non-containing chamber.

2. The evaporated fuel treating apparatus according to claim 1, wherein an axial length of said heat storage element non-containing chamber is not less than 2 mm and not more than 30 mm.

3. The evaporated fuel treating apparatus according to claim 1, wherein a throttle portion which reduces a circulation area of the fluid is formed at both ends of said delay diffusion chamber.

4. The evaporated fuel treating apparatus according to claim 1, wherein an auxiliary adsorption chamber in which activated carbon formed into a honeycomb shape is disposed and which does not have the heat storage material is provided on the other end side of said passage with respect to said heat storage element non-containing chamber.
